(19) United States
(12) Patent Application Publication
(10) Pub. No.: US 2025/0052868 A1
(43) Pub. Date: Feb. 13, 2025

(54) LIGHT DETECTION AND RANGING RECEIVING SYSTEM AND LIGHT DETECTION AND RANGING SYSTEM

(71) Applicants: Tsinghua University, Beiling (CN); HON HAI PRECISION INDUSTRY CO., LTD., New Taipei (TW)

(72) Inventors: XIAO-HENG WANG, Beijing (CN); Jun ZHU, Beiling (CN)

(21) Appl. No.: 18/794,207

(22) Filed: Aug. 5, 2024

(30) Foreign Application Priority Data
Aug. 10, 2023 (CN) 202311008624.3

(51) Int. Cl. G01S 7/481; G01S 17/931

(52) U.S. Cl. CPC G01S 7/4817; G01S 17/931

(57) ABSTRACT

A light detection and ranging receiving system, comprises a plurality of lenses, an aperture and a detector. A vertex curvature of a lens farthest from the detector is positive. Lenses on left and right sides of the aperture are asymmetric relative to the aperture. An instantaneous field of view angle gradually increases from a central field of view of the light detection and ranging receiving system to an edge field of view, and a negative distortion also gradually increases.

### CROSS-REFERENCE TO RELATED APPLICATIONS

This application claims all benefits accruing under 35 U.S.C. § 119 from China Patent Application No. 202311008624.3, filed on Aug. 10, 2023, in the China National Intellectual Property Administration, the contents of which are hereby incorporated by reference.

### FIELD

The disclosure relates to a light detection and ranging (LiDAR) receiving system and a LiDAR system.

### BACKGROUND

LiDAR can obtain environmental information in three-dimensional space, and has the characteristics of strong initiative, accurate ranging and high flexibility. At present, LiDAR is widely used in many fields such as surveying and mapping, remote sensing, road planning, space monitoring and autonomous driving. For conventional

LiDAR, for LiDAR using linear array or planar array detectors, the LiDAR receiving system is a combination of a series of lenses. The focal length, field of view, and aperture of the LiDAR receiving system jointly determine the effect of three-dimensional environment detection. The larger the field of view, the larger the spatial range of detection. After the detector is selected, the larger the focal length, the higher the angular resolution of the system and the higher the target measurement accuracy. The aperture of the LiDAR receiving system determines the receiving power of the LiDAR. The larger the aperture, the greater the energy of the received target echo. Through the combination of these lenses and the detector, the LiDAR has a fixed field of view and angular resolution. In order to obtain more echo energy, the LiDAR receiving system has a larger entrance pupil. At the same time, the LiDAR receiving system maintains good imaging quality. For echo beams in any direction within the full field of view, the energy concentration of a single pixel can reach more than 90%.

The LiDAR receiving system is responsible for transmitting the diffusely reflected light beam of the target. Targets with different fields of view are distributed at different positions of the detector in a certain imaging relationship. The existing LiDAR receiving system follows the function projection relationship of Y=f*tan θ. In the formula, Y is the height of the imaging surface, θ is the angle between the direction of the target and the optical axis, that is, the half field of view angle, and f is the focal length of the LiDAR receiving system. Under the premise that the chip size of the detector is determined, increasing the field of view angle of the objective lens will reduce the focal length of the system. That is, while expanding the detection range, the spatial resolution of the target will also decrease. The most ideal LiDAR receiving system needs to have both a large field of view and a long focal length, but due to the constraints of the projection relationship, it is impossible to increase the field of view while ensuring the focal length. Expanding the field of view by replacing a larger array of detectors will increase the cost of the system and increase the complexity of the LiDAR receiving system. The contradiction between expanding the field of view and maintaining the focal length of the LiDAR receiving system limits the application of LiDAR.

### BRIEF DESCRIPTION OF THE DRAWINGS

Implementations of the present technology will now be described, by way of example only, with reference to the attached figures, wherein:

FIG. 1 is a structural schematic diagram of a linear array scanning light detection and ranging (LiDAR) system.

FIG. 2 is a schematic diagram of the effective detection field of view of a linear array scanning LiDAR.

FIG. 3 is a field focal length function curve of a linear array scanning LiDAR receiving system.

FIG. 4 is a structural schematic diagram of a linear array scanning LiDAR receiving system provided by an embodiment of the present disclosure.

FIG. 5 is a diagram of an energy concentration of a linear array scanning

LiDAR receiving system provided by an embodiment of the present disclosure.

FIG. 6 is a diagram of the instantaneous field of view (IFOV) angle of the linear array scanning LiDAR receiving system of the present disclosure under different fields of view in the vertical direction.

FIG. 7 is a diagram of the number of pixels occupied by an image height of a car at different distances of a linear array scanning LiDAR receiving system provided by an embodiment of the present disclosure.

FIG. 8 is a schematic diagram of the entrance pupil shape of a linear array scanning LiDAR receiving system provided by an embodiment of the present disclosure at different field of view angles.

FIG. 9 is a diagram of the entrance pupil area of a linear array scanning LiDAR receiving system provided by an embodiment of the present disclosure at different field of view angles.

FIG. 10 is a schematic diagram of the structure of a LiDAR receiving system provided by a first embodiment of the present disclosure.

FIG. 11 is a schematic diagram of the structure of a LiDAR receiving system provided by a second embodiment of the present disclosure.

FIG. 12 is a schematic diagram of the structure of a LiDAR receiving system provided by a third embodiment of the present disclosure.

FIG. 13 is a schematic diagram of the structure of a LiDAR receiving system provided by a fourth embodiment of the present disclosure.

FIG. 14 is a schematic diagram of the distortion of the LiDAR receiving system provided by the first embodiment of the present disclosure.

FIG. 15 is a schematic diagram of the distortion of the LiDAR receiving system provided by the second embodiment of the present disclosure.

FIG. 16 is a schematic diagram of the distortion of the LiDAR receiving system provided by the third embodiment of the present disclosure.

FIG. 17 is a schematic diagram of the distortion of the LiDAR receiving system provided by the fourth embodiment of the present disclosure.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “comprise, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly comprise at least one of the features. The term of “multiple times” means at least two times, such as two times, three times, etc., unless otherwise expressly and specifically defined.

The present disclosure provides a light detection and ranging (LiDAR) system. The LiDAR system comprises a transmitting system, a receiving system, a scanning system, a data processing system, and a control unit, wherein aninstantaneous field of view (IFOV) of the receiving system is variable and non-uniform. The IFOV refers to a field of view corresponding to each pixel. Among them, a maximum IFOV of the receiving system is more than 1.2 times a minimum IFOV. Preferably, the maximum IFOV of the receiving system is 1.5 to 5 times the minimum IFOV. More preferably, the maximum IFOV of the receiving system is 3 to 4 times the minimum IFOV.

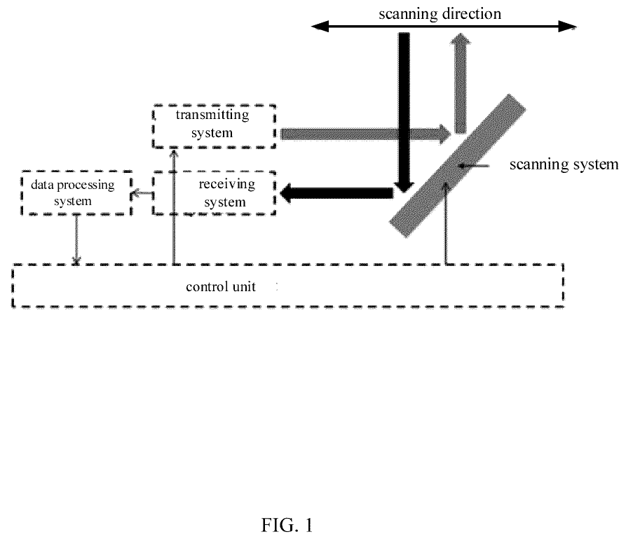

Please refer to FIG. 1. an embodiment of the present disclosure provides a linear scanning LiDAR system. The linear scanning LiDAR system comprises a transmitting system, a receiving system, a scanning system, a data processing system, and a control unit. The transmitting system actively emits a straight-line laser beam, and the laser beam is received by the linear array detector of the connected system after diffuse reflection by the target. The data processing system processes the received echo signal to obtain the distance information of the target. The linear array scanning LiDAR scans in the horizontal dimension through the scanning system to realize a detection of the rectangular field of view.

For the conventional one-dimensional scanning LiDAR, the relationship between an image height H of the target on the linear array detector and the field of view angle ω is as follows:

$$H = f \cdot tan ω \qquad ( 1 )$$

Wherein f is the focal length of the LiDAR receiving system. The IFOV corresponding to the conventional LiDAR is

$$IFOV ( ω ) = \frac{{d}_{pixel}}{f {sec}^{2} ω} \qquad ( 2 )$$

Wherein dₚᵢₓₑₗ is the size of a single pixel of the linear array detector. The IFOV of the LiDAR is approximately equal in the whole field of view.

Set the LiDAR system to be placed at a center height of the vehicle. When detecting at a long distance, the field of view angle occupied by the target is small and located at the center of the LiDAR's field of view. Reducing the IFOV of the central field of view can improve the spatial resolution of the target. The field focal length (FFL) can be used to control the IFOV of the optical system, which is defined as follows:

$$FFL ( ω ) = \frac{Δ H}{Δω} \qquad ( 3 )$$

Wherein Δω is a small change in the field of view angle, and AH is the change in image height caused by a small change in the field of view angle. Currently, the IFOV of the LiDAR is

$$IFOV ( ω ) = \frac{{d}_{pixel}}{FFL ( ω )} \qquad ( 4 )$$

Given the detector, FFL(ω) determines the IFOV of the optical system. Therefore, by establishing a suitable FFL(ω) function and designing the corresponding receiving system, the non-uniform distribution of the LiDAR IFOV can be achieved.

The condition for the LiDAR system to detect the target is that the target image height occupies 2 pixels of the linear array detector, while the recognition of the target requires the image height to occupy 8 pixels. In this embodiment, a single photon avalanche diode (SPAD) with a single pixel size dₚᵢₓₑₗ of 30 μm and 198 pixels arranged in the vertical direction is selected as the linear array detector of the LiDAR receiving system. Taking the vertical field of view angle as 28°, it can be seen from formula (1) that the focal length f of the corresponding conventional receiving system is 11.91 mm. Substituting the focal length f and the pixel size dₚᵢₓₑₗ into formula (2), it can be obtained that the IFOV from the edge to the center of the vertical field of view is ranged from 0.136° to 0.144°, and the IFOV changes very little in the whole field of view.

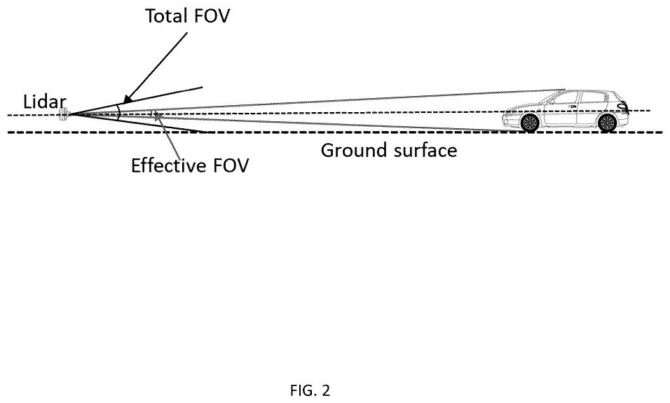

The effective detection of target vehicles on the road by the LiDAR is shown in FIG. 2. A height of the vehicle is about 1.5m. When the target vehicle is 150m away from the LiDAR, the effective field of view occupied by the vehicle is only 0.57°. For a conventional receiving system with a central field of view IFOV of 0.144°, the image height corresponding to the effective field of view of the target of 0.57° is less than 4 pixels, which makes the LiDAR only detect the target but cannot identify the target. If the FFL principle is adopted, the IFOV of the central field of view is reduced while keeping the total field of view unchanged, so that when the target vehicle is 150m away from the LiDAR, the image height can occupy more than 8 pixels of the detector, and the target can be identified.

For the line field of view, FFL(ω) can be described by the polynomial shown in formula (5), where ki is a constant coefficient and o is the radian value of the field of view.

$$FFL ( ω ) = {\sum }_{i = 0}^{n} {k}_{i} {ω}^{i} \qquad ( 5 )$$

The integral of FFL(ω) over the total field of view is the length of the linear array detector, that is

$$H ( {ω}_{max} ) = 2 {\int }_{0}^{{ω}_{max}} FFL ( ω ) d ω \qquad ( 6 )$$

Wherein, ωₘₐₓ is the half field of view angle of the receiving system. In order to control the speed at which the IFOV of the receiving system changes with the field of view, in addition to the central field of view, the IFOVs at half field of view angles of 4°, 8° and 12° are pre-set. In order to meet the IFOV requirements at the preset four angles, FFL(ω) is described by the first five terms in formula (5), that is, the coefficients of the FFL(ω) polynomial are from k0 to k4. Substitute the radian values of the preset four specific field of view angles into formula (4), and after obtaining the corresponding FFL(ω), substitute it into formula (5) to obtain the following set of equations:

$$\{ \begin{matrix}FFL ( 0 ) = {k}_{0} \\ FFL ( \frac{π}{45} ) = {k}_{0} + {k}_{1} ( \frac{π}{45} ) + {{k}_{2} ( \frac{π}{45} )}^{2} + {{k}_{3} ( \frac{π}{45} )}^{3} + {{k}_{4} ( \frac{π}{45} )}^{4} \\ FFL ( \frac{2 π}{45} ) = {k}_{0} + {k}_{1} ( \frac{2 π}{45} ) + {{k}_{2} ( \frac{2 π}{45} )}^{2} + {{k}_{3} ( \frac{2 π}{45} )}^{3} + {{k}_{4} ( \frac{2 π}{45} )}^{4} \\ FFL ( \frac{π}{15} ) = {k}_{0} + {k}_{1} ( \frac{π}{15} ) + {{k}_{2} ( \frac{π}{15} )}^{2} + {{k}_{3} ( \frac{π}{15} )}^{3} + {{k}_{4} ( \frac{π}{15} )}^{4}\end{matrix} \qquad ( 7 )$$

Combining formulas (6) and (7) to obtain the values of k0 to k4, and obtain the initial polynomial of FFL(ω). The initial FFL(ω) function fluctuates greatly between different fields of view, which is not conducive to the design of the actual system. In order to make FFL(ω) smoother and monotonically decreasing, FFL(ω) needs to satisfy formula (8):

$$\frac{dFFL ( ω )}{d ω} < 0 \qquad ( 8 )$$

The least square method is used to iteratively adjust kl to k4. When adjusting the coefficients, the constraints shown in formulas (6) and (8) must be followed.

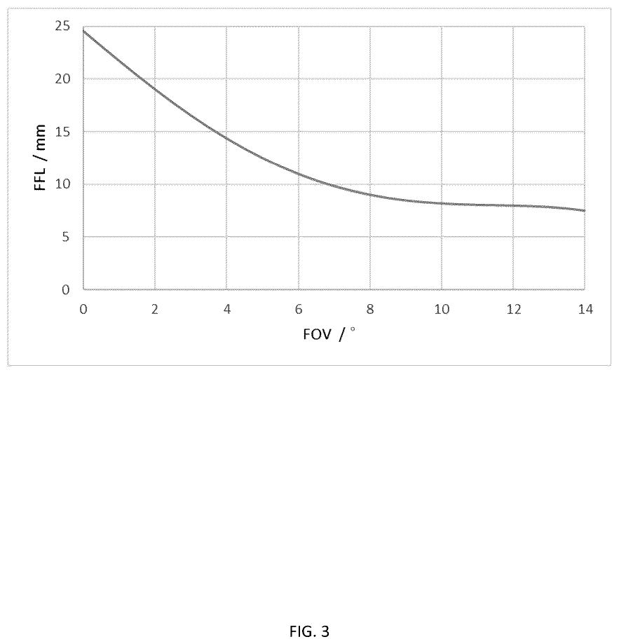

Formula (9) is the FFL(ω) of the receiving system designed in this embodiment. The relationship between its value and the field of view is shown in FIG. 3, which has the characteristics of high center and low edge.

$$FFL ( ω ) = - 9326 {ω}^{4} + 3668.9 {ω}^{3} + 46.323 {ω}^{2} - 164.22 ω + 24.55 \qquad ( 9 )$$

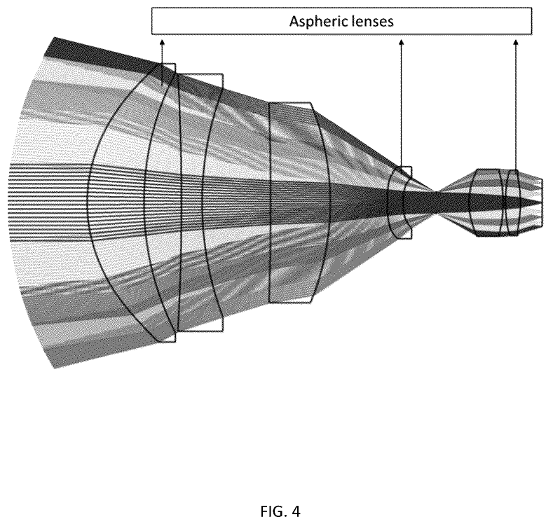

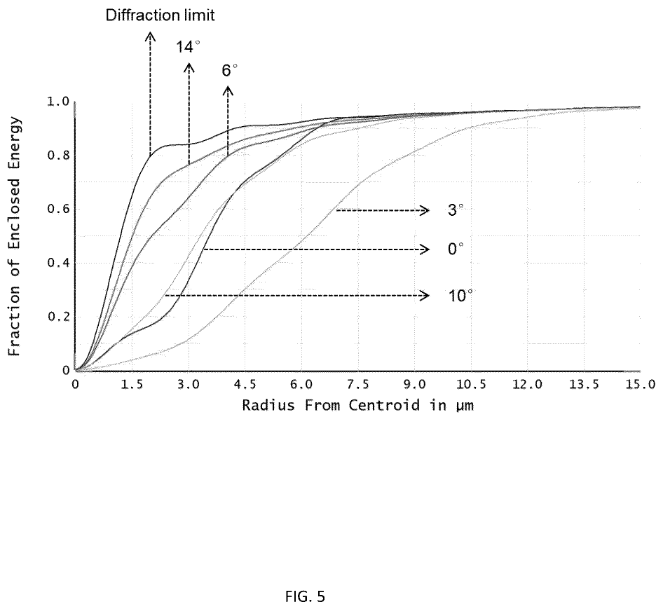

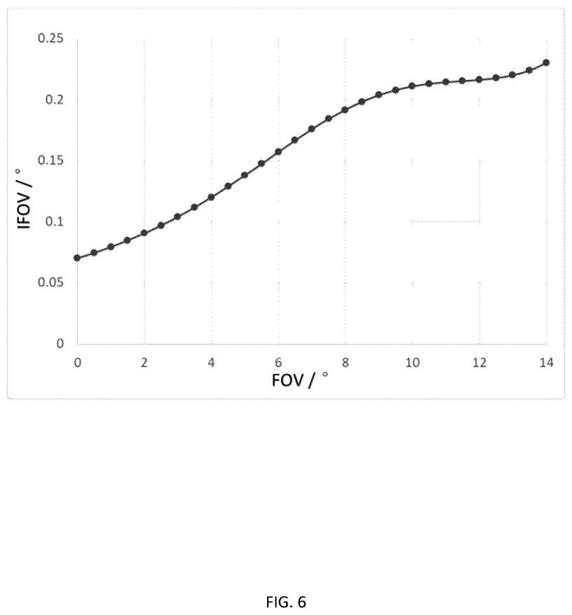

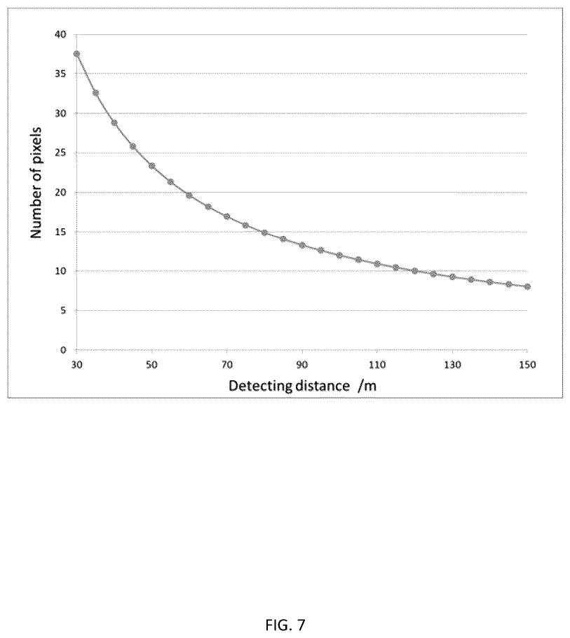

According to the FFL(ω) function shown in formula (7), an evaluation function is written to design the corresponding receiving system. The evaluation function comprises image height, IFOV and aberration of different field of view angles. The designed receiving system is shown in FIG. 4, which consists of three aspherical lenses and three spherical lenses. The energy concentration of the receiving system is shown in FIG. 5. The echo beam of each field of view can be concentrated within one pixel with an energy ratio of more than 98%, which has a good energy collection effect. The IFOV of the full field of view of the system is shown in FIG. 6. It can be seen that, the IFOV of the central field of view is the smallest, which is 0.07°. FIG. 7 shows the number of pixels of the detector occupied by the image height when the target vehicle is within 30 to 150m from the LiDAR. In this distance range, conventional cars can be imaged in more than 8 pixels, which meets the LiDAR's recognition requirements for targets. The receiving system is equipped with a corresponding line spot emission system, and three-dimensional information of the spatial environment can be obtained by scanning.

Table 1 compares the detection effect of the conventional system and the FFL system designed in this embodiment on a 1.5 m high car. The two optical systems have the same field of view. According to the critical pixel conditions for discovering and identifying targets, the distance at which the FFL system discovers and identifies targets is twice that of the conventional system. When the car is traveling at a speed of 100 km/h, the safe distance needs to reach 100m. At this time, the image height of the target vehicle on the conventional LiDAR detector is only 6 pixels, and the target cannot be accurately identified. For the FFL system, the vehicle image height can reach 12 pixels, which can clearly identify the target vehicle.

TABLE 1
Comparison of detection effects of
conventional system and FFL system

| | Conventional | FFL |
|---|---|---|
| | system | system |
| Field of view | 28° | 28° |
| Detection distance/m | 300 | 600 |
| Identification distance/m | 75 | 150 |
| Image height @100 m vehicle distance | 6 pixels | 12 pixels |

It can be understood that the LiDAR provided by the present disclosure is not limited to the linear array scanning type, but can also be a planar array scanning type.

The IFOV of the LiDAR of this embodiment gradually decreases from the edge to the center of the field of view. Under the premise of not reducing the detection range, the receiving system can effectively improve the detection and identification distance of the LiDAR for the target. It can be seen from FIG. 6 that in this embodiment, the maximum IFOV of the edge field of view is 0.23°, and the minimum IFOV of the center field of view is 0.07°. The maximum IFOV of the edge field of view is 3.26 times the minimum IFOV of the center field of view. It can be understood that the maximum IFOV of the edge field of view is not limited to the minimum IFOV of the central field of view, and can also be more than 1.2 times, preferably 1.5 to 5 times, and more preferably 3 to 4 times.

In response to the needs of vehicle-mounted detection, this embodiment establishes the FFL(ω) function of the LiDAR and designs the corresponding optical system. However, the FFL(ω) function of the LiDAR is not unique. In the specific design, it is necessary to optimize the FFL(ω) function and the corresponding system according to the requirements of vehicle-mounted detection and the requirements for improving the performance of the LiDAR. Compared with the conventional system, the optical system of this embodiment reduces the IFOV of the central field of view of the FFL-type LiDAR from 0.144° to 0.07°, which more than doubles the distance for the LiDAR to detect and identify targets.

In this embodiment, the LiDAR is set to be placed at the middle height position of the vehicle, and the long-distance vehicle is located at the center of the field of view of the LiDAR, and the FFL value of the central field of view of the LiDAR is the largest. In practical applications, it is necessary to specifically design the corresponding IFOV(ω) and FFL(ω) according to the placement position of the LiDAR, the direction of the optical axis and the characteristics of the detected environment. If the distant target is not in the center of the LiDAR's field of view, it is necessary to increase the FFL value of the field of view where the target is located in order to improve the detection distance and recognition distance of the target. The IFOV angle of the field of view where the distant target is located is designed to be smaller than the IFOV angle of other fields of view, that is, using the same detector, under the premise of having the same field of view range, the number of pixels occupied by the distant target of the LiDAR of this embodiment is greater than the number of pixels of other LiDARs. IFOV(ω) and FFL(ω) can be designed according to the field of view of the LiDAR where the target is located. That is, the IFOV of the LiDAR field of view where the target is located can be made smaller than the IFOV of other fields of view.

The power of the laser pulse received by the LiDAR is proportional to the entrance pupil area of the receiving system and inversely proportional to the square of the detection distance. The distance to the target corresponding to the center field of view of the vehicle-mounted LiDAR is farther, and the distance to the target corresponding to the edge field of view is relatively close. As the detection distance increases, the received power will drop rapidly, which will affect the LiDAR's detection effect on the road environment.

In order to compensate for the power drop in the center field of view caused by the increase in the detection distance, the entrance pupil of the LiDAR's center field of view should be larger than the edge field of view. The entrance pupil area of the conventional receiving system is consistent throughout the entire field of view, and has the same beam collection capability, which cannot meet the optimal working requirements. The entrance pupil of the FFL receiving system designed in this embodiment is small at the edge and large at the center, and the central field of view has a stronger ability to collect beams, which is consistent with the characteristic that the target distance in the central field of view is farther.

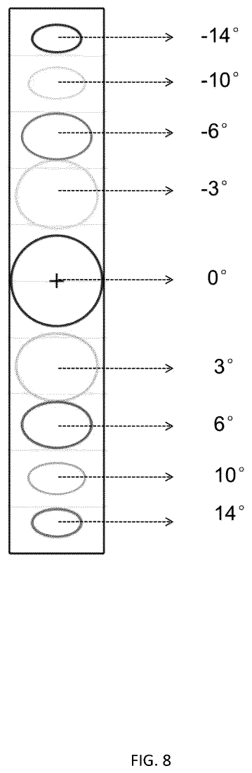

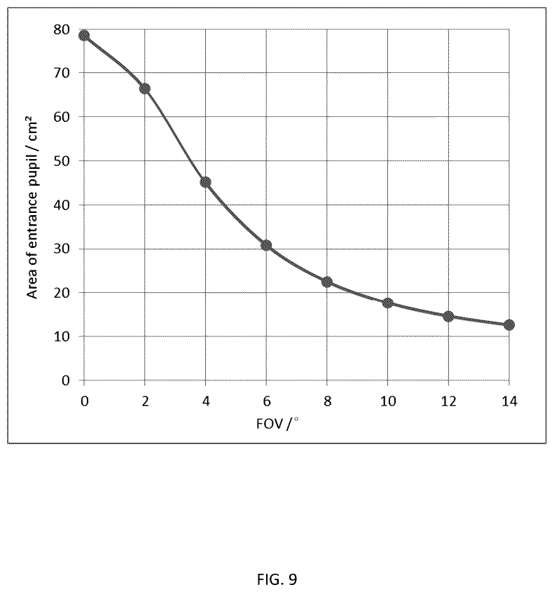

The entrance pupil shapes of the FFL receiving system in different fields of view designed in this embodiment are shown in FIG. 8. From the edge field of view to the center field of view, the entrance pupil gradually increases. The entrance pupil area of the full field of view is shown in FIG. 9. The area of the edge field of view is only 12.6 cm², while the area of the center field of view can reach 78.66 cm². The center entrance pupil area is more than 6.24 times that of the edge, which can effectively improve the beam collection ability of the center field of view of the LiDAR. The FFL type receiving system improves the distance of the center field of view to discover and identify the target through the non-uniform distribution of IFOV. With the larger entrance pupil area of the center field of view, the LiDAR can have a better detection effect.

It can be understood that in practical applications, different fields of view of the FFL system correspond to different entrance pupil areas according to the placement position of the LiDAR, the direction of the optical axis and the characteristics of the detected environment. According to the FFL (ω) function and the detection distance requirements, the corresponding entrance pupil area is designed for different fields of view, which can better play the performance of the LiDAR.

The present disclosure proposes a LiDAR different from the traditional imaging system, which does not follow the functional projection relationship of H=f*tan ω. By designing a reasonable functional relationship between the image height H and the half field of view angle ω, the IFOV of the field of view where the target is located can be compressed while keeping the total detection space unchanged, thereby improving the recognition distance of the target. When the IFOV of the target field of view of the LiDAR is reduced, the IFOV of other fields of view will become larger, but the target distance corresponding to other fields of view is very close, so it will not affect the recognition of close-range targets. The IFOV of the LiDAR identifying the target of the present disclosure shows a large difference with the distribution of the field of view, that is, the IFOV angle of the receiving system is variable and non-uniform, that is, the field of view angle corresponding to each pixel of the detector in the receiving system is variable and non-uniform, so the number of pixels occupied by the target is variable and non-uniform.

Through the differential distribution of IFOV with the field of view, it is possible to compress the IFOV of the field of view where the target is located without reducing the total field of view angle of the detection. When the same detector is used and the same field of view is used, if the IFOV₁ of the target field of view of the conventional system is θ, then the IFOV₂ of the field of view where the target of this new LiDAR is located is less than θ. Compared with conventional LiDARs, the multiple B of the reduction of the IFOV of the field of view where the target of this new LiDAR is located determines the increase multiple of the distance of target discovery and target recognition. For example, β=IFOV₁/IFOV₂, when β=2, the distance for discovering and identifying the target is increased to twice that of the conventional system. Moreover, the LiDAR provided by the present disclosure can reduce the size of the detector, reduce the cost, and read faster.

Moreover, the entrance pupil of the receiving system of the LiDAR has the characteristics of small edges and large centers, and the entrance pupil area of the central field of view can reach more than 6.24 times that of the edges, which meets the demand for a longer detection distance of the central field of view of the LiDAR. The sensitivity of the LiDAR of the present disclosure is improved. This LiDAR with non-uniform distribution of IFOV can discover and identify targets on the road earlier, which is beneficial for smart cars to identify potential risks in the driving environment, thereby controlling the driving state of the car, and has important application value in the vehicle field.

The present disclosure provides a LiDAR, which comprises a LiDAR receiving system. The LiDAR receiving system comprises: a plurality of lenses, an aperture and a detector, the vertex curvature of the lens farthest from the detector is positive, and the lenses on the left and right sides of the aperture are asymmetric relative to the aperture. The so-called “asymmetric” means that the number, size, shape of the lenses on the left and right sides of the aperture or the length of the lens groups on the left and right sides of the aperture are different. Preferably, the length of the lens groups on one side and the other side of the aperture differs by more than 1.5 times. The IFOV gradually increases from the central field of view of the LiDAR receiving system to the edge field of view, and the negative distortion also gradually increases. The detector in the receiving system is a surface array detector or a line array detector.

In addition, the entrance pupil area of the receiving system is variable. As an example, the entrance pupil area of the receiving system gradually increases from the edge field of view to the central field of view.

Specifically, the present disclosure lists the following four LiDAR receiving systems. It can be understood that the LiDAR receiving system of the present disclosure is not limited to the following four.

### First Embodiment

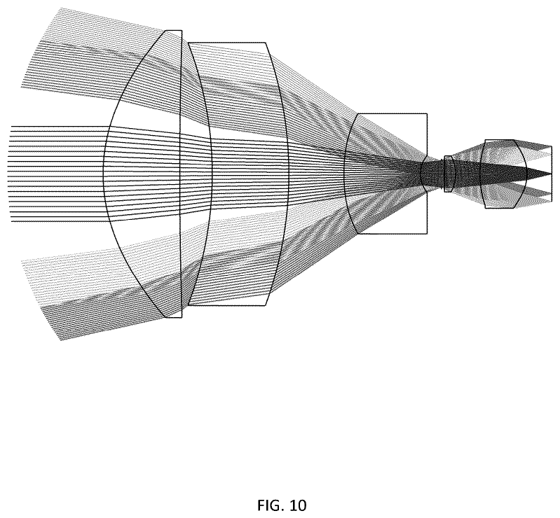

Please refer to FIG. 10. The LiDAR receiving system provided in the first embodiment comprises 5 lenses. The first, second and third lenses are located on one side of the aperture, and the fourth, fifth lenses and the detector are located on the other side of the aperture. The first, third and fifth lenses are double-sided aspheric lenses, and the second and fourth lenses are spherical lenses. The focal length of the traditional LiDAR receiving system is 21.5 mm. When the half-image height is 2.85 mm, the field of view angle is only 15.1°. The field of view angle of the LiDAR receiving system of this embodiment is 25°. Under the premise that the half-image height is 2.85 mm, the center resolution and the center focal length remain unchanged, and the observation field of view angle is greatly improved. The relevant parameters of the LiDAR receiving system provided in this embodiment are shown in Table 1:

TABLE 1
Optical specifications of the LiDAR receiving
system provided in the first embodiment

| | | Laser | Field | Half image | System total |
|---|---|---|---|---|---|
| Focal length | F# | wavelength | of view | height | length |
| 21.5 mm | 2 | 880 nm | 25° | 2.85 mm | 46.8 mm |

### Embodiment

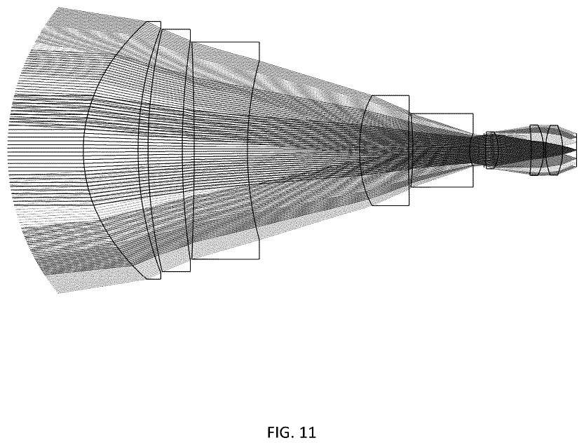

Please refer to FIG. 11, the LiDAR receiving system provided in the second embodiment comprises 8 lenses, including eight lenses. The first, second, third, fourth and fifth lenses are located on one side of the aperture, and the sixth, seventh and eighth lenses and the detector are located on the other side of the aperture. The surface of the first lens away from the detector is aspherical, and the other surface of the first lens and all surfaces of other lenses are spherical. The field of view of the LiDAR receiving system of this embodiment is 18° and the focal length is 25 mm. Under the premise that the half image height is 2.2 mm and the central focal length remains unchanged, the field of view of the tangent projection optical system is only 10.06°. The field of view of the LiDAR receiving system of this embodiment has been greatly improved.

TABLE 2
Optical specifications of the LiDAR receiving
system provided by the second embodiment

| | | Laser | Field | Half image | System total |
|---|---|---|---|---|---|
| Focal length | F# | wavelength | of view | height | length |
| 25 mm | 1.6 | 905 nm | 18° | 2.2 mm | 64.5 mm |

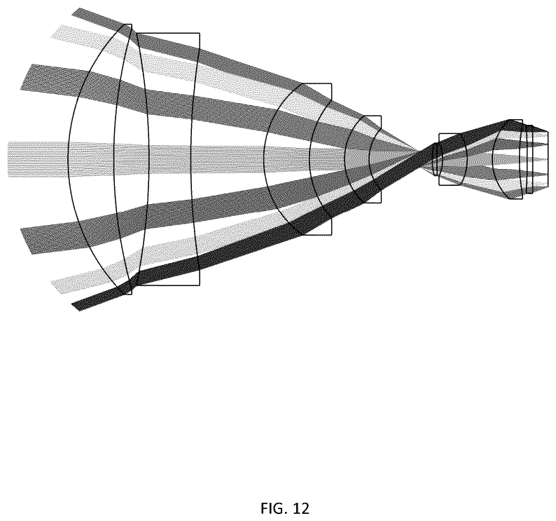

Please refer to FIG. 12, the LiDAR receiving system provided by the third embodiment comprises eight lenses. The first, second, third and fourth lenses are located on one side of the aperture, and the fifth, sixth, seventh and eighth lenses and the detector are located on the other side of the aperture. The eight lenses are all spherical lenses. The field of view of the LiDAR receiving system of this embodiment is 40° and the focal length is 45 mm. Under the premise that the half image height is maintained at 9 mm and the central focal length is 45 mm, the field of view of the traditional LiDAR receiving system is only 22.6°, while the field of view of the LiDAR receiving system described in this embodiment can reach 40°.

TABLE 3
Optical specifications of the LiDAR receiving
system provided by the third embodiment

| | | Laser | Field | Half image | System total |
|---|---|---|---|---|---|
| Focal length | F# | wavelength | of view | height | length |
| 45 mm | 4 | 1064 nm | 40° | 9 mm | 157.6 mm |

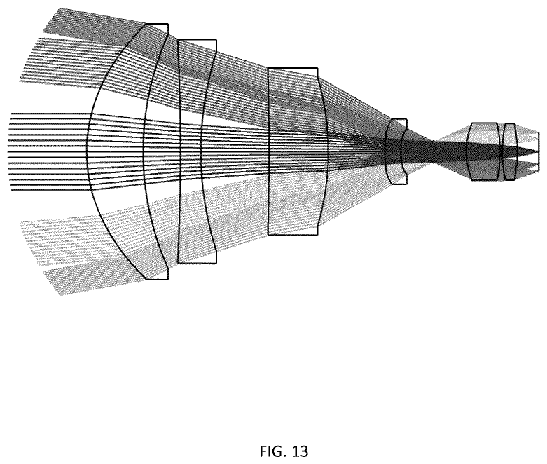

Please refer to FIG. 13, the LiDAR receiving system provided by the fourth embodiment comprises six lenses. The first, second, third and fourth lenses are located on one side of the aperture, and the fifth, sixth lenses and the detector are located on the other side of the aperture. The first, fourth and sixth lenses are double-sided aspheric lenses, and the second, third and fifth lenses are spherical lenses. When the focal length of the traditional LiDAR receiving system is 30 mm and the half image height is 2.9 mm, the field of view angle is only 11.04°. The field of view angle of the LiDAR receiving system of this embodiment is 20°. Under the premise that the half image height is 2.9 mm unchanged, the center resolution and the center focal length remain unchanged, the observed field of view angle has been greatly improved.

TABLE 4
Optical specifications of the LiDAR receiving
system provided by the fourth embodiment

| | | Laser | Field | Half image | System total |
|---|---|---|---|---|---|
| Focal length | F# | wavelength | of view | height | length |
| 30 mm | 2.45 | 905 nm | 20° | 2.9 mm | 68.5 mm |

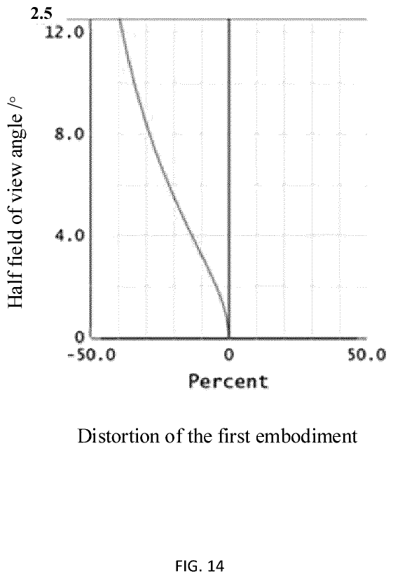

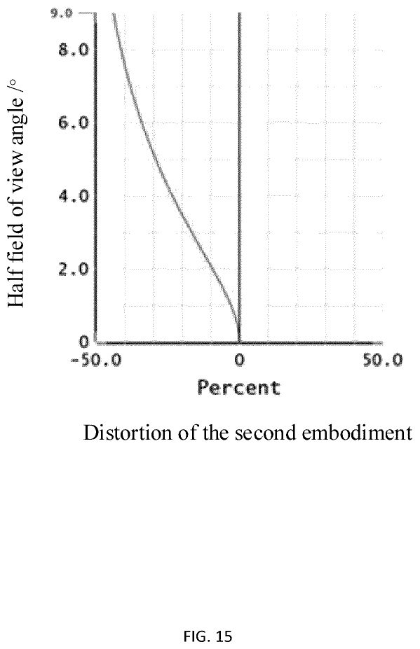

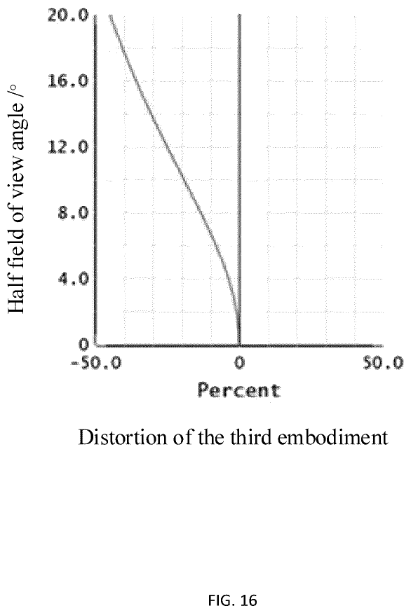

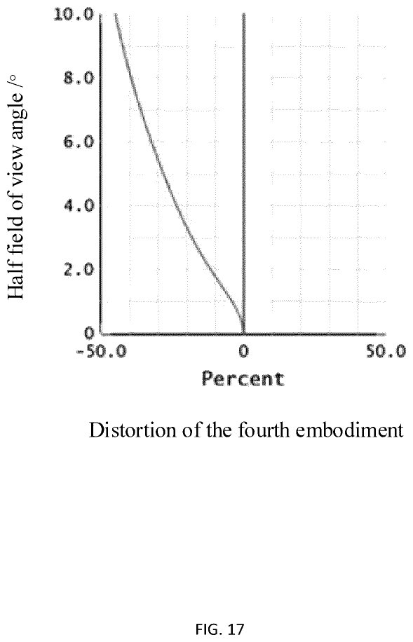

Please refer to FIGS. 14-17, which are the distortions of the LiDAR receiving systems of the first to fourth embodiments of the present disclosure. As can be seen from FIGS. 14-17, the distortions of the maximum field of view of the LiDAR receiving systems of the first to fourth embodiments of the present disclosure are all above-40%, and this negative distortion increases the observed field of view. These four embodiments prove the feasibility of the LiDAR receiving system.

It can be understood that the structure of the receiving system is not limited to the above four structures, but can also be other structures. The maximum IFOV angle of the edge field of view of the receiving system is more than 1.2 times the minimum IFOV angle of the central field of view. Preferably, the maximum IFOV angle of the edge field of view of the receiving system is 1.5 to 5 times the minimum IFOV angle of the central field of view. Preferably, the maximum IFOV of the edge field of view of the receiving system is 3 to 4 times the minimum IFOV of the central field of view.

Compared with the traditional optical system with the function projection of Y=f*tan θ, the LiDAR receiving system of the present disclosure has a large negative distortion. In the formula, Y is the image plane height, A is a constant term, θ is the angle between the target direction and the optical axis, and f is the focal length of the optical system. When θ=0, that is, in the central field of view, the resolution and imaging position are consistent with the traditional LiDAR. Due to the existence of negative distortion, the edge field of view increases the detection field of view of the LiDAR.

The LiDAR receiving system of the present disclosure has a large negative distortion. In the central field of view, this optical system has a large focal length, which makes the spatial resolution of the target in the field of view higher. In the larger field of view area of the central field of view, the system has a large negative distortion, which can reduce the imaging height. Under the premise that the size of the optical system photosensitive chip is determined, the field of view angle of the LiDAR receiving system will be expanded due to the reduction of the imaging height caused by negative distortion. Thereby, the LiDAR can expand the detection range while maintaining the target observation accuracy. At the same time, this receiving system with large negative distortion can also be used to improve the resolution of the LiDAR. If the field of view of the LiDAR is kept unchanged, the focal length of the receiving system can be increased, which can effectively improve the resolution of the central field of view.

Conventional LiDAR receiving systems have the same entrance pupil for any field of view, that is, the ability to collect echo energy in the entire field of view is consistent. However, there are large differences in the target distances corresponding to different fields of view of the LiDAR. For example, the target distance corresponding to the central field of view is farther, while the target distance corresponding to the edge field of view is closer. Only when the central field of view has a larger entrance pupil size can the decrease in receiving power caused by the increase in target distance be compensated. That is, the entrance pupil area of the receiving system gradually increases from the edge field of view to the central field of view. The receiving system with the same size entrance pupil in the entire field of view obviously cannot enable the LiDAR to achieve the best detection effect. The LiDAR receiving system described in the present disclosure has different entrance pupil sizes in different fields of view, that is, the entrance pupil area of the receiving system is variable, and the entrance pupil size of the LiDAR can be controlled in a targeted manner according to the different distances of the LiDAR detection target. Increase the entrance pupil of the field of view where the long-distance target is located to compensate for the decrease in receiving power caused by the increase in distance.

The LiDAR receiving system of the present disclosure can greatly improve the spatial range of observation while ensuring that the focal length remains unchanged. This avoids the use of a larger array detector and can reduce costs. At the same time, if the field of view remains unchanged, the LiDAR receiving system of the present disclosure can effectively improve the resolution of the central field of view. The LiDAR receiving system of the present disclosure has different receiving areas for different fields of view, and can design the receiving area of the corresponding field of view according to specific detection requirements, thereby achieving better detection effects. In addition, the LiDAR receiving system of the present disclosure has different effective optical receiving apertures, i.e., the entrance pupil area of the LiDAR receiving system, for different fields of view, which can better exert the detection effect of the LiDAR.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may comprise some indication in reference to certain steps. However, the indication used is only to be viewed for identification purposes and not as a suggestion as to an order for the steps.

What is claimed is:

1. A light detection and ranging receiving system comprising:
a plurality of lenses, an aperture and a detector, wherein a vertex curvature of a lens of the plurality of lenses farthest from the detector is positive, lenses of the plurality of lenses on left and right sides of the aperture are asymmetric placed relative to the aperture, an instantaneous field of view angle gradually increases from a central field of view of the light detection and ranging receiving system to an edge field of view of the light detection and ranging receiving system, and a negative distortion gradually increases.

2. The light detection and ranging receiving system of claim 1, wherein a maximum instantaneous field of view angle of the edge field of view is more than 1.2 times a minimum instantaneous field of view angle of the central field of view.

3. The light detection and ranging receiving system of claim 1, wherein a maximum instantaneous field of view angle of the edge field of view is 1.5 to 5 times a minimum instantaneous field of view angle of the central field of view.

4. The light detection and ranging receiving system of claim 1, wherein a maximum instantaneous field of view angle of the edge field of view is 3 to 4 times a minimum instantaneous field of view angle of the central field of view.

5. The light detection and ranging receiving system of claim 1, wherein an entrance pupil area of the light detection and ranging receiving system is variable.

6. The light detection and ranging receiving system of claim 5, wherein the entrance pupil area of the light detection and ranging receiving system gradually increases from the edge field of view to the central field of view.

7. The light detection and ranging receiving system of claim 1, comprising five lenses, wherein a first lens, a second lens and a third lens of the five lenses are located on a side of the aperture, a fourth lens, a fifth lens of the five lenses and the detector are located on another side of the aperture, the first lens, the third lens and the fifth lens are double-sided aspheric lenses, and the second lens and the fourth lens are spherical lenses.

8. The light detection and ranging receiving system of claim 1, comprising eight lenses, wherein the first lens, the second lens, the third lens, the fourth lens and the fifth lens of the eight lenses are located on a side of the aperture, the sixth lens, the seventh lens and the eighth lens of the eight lenses and the detector are located on another side of the aperture.

9. The light detection and ranging receiving system of claim 8, wherein a surface of the first lens away from the detector is an aspheric surface, and another surface of the first lens and all surfaces of other lenses of the eight lenses are spherical surfaces.

10. The light detection and ranging receiving system of claim 1, comprising eight lenses, wherein a first lens, a second lens, a third lens, and a fourth lens of the eight lenses are located on a side of the aperture, a fifth lens, a sixth lens, a seventh lens, and an eighth lens of the eight lenses and the detector are located on another side of the aperture, and each of the eight lenses is a spherical lens.

11. The light detection and ranging receiving system of claim 1, comprising six lenses, wherein a first lens, a second lens, a third lens, and a fourth lens of the six lenses are located on a side of the aperture, a fifth lens, a sixth lens of the six lenses and the detector are located on another side of the aperture, the first lens, the fourth lens, and the sixth lens are double-sided aspherical lenses, and the second lens, the third lens, and the fifth lens are spherical lenses.

12. A light detection and ranging system comprising a light detection and ranging receiving system, wherein the light detection and ranging receiving system comprises a plurality of lenses, an aperture and a detector, a vertex curvature of a lens of the plurality of lenses farthest from the detector is positive, lenses of the plurality of lenses on left and right sides of the aperture are asymmetric placed relative to the aperture, an instantaneous field of view angle gradually increases from a central field of view of the light detection and ranging receiving system to an edge field of view, and a negative distortion gradually increases.
